(19) United States
(12) Patent Application Publication
(10) Pub. No.: US 2026/0030485 A1
(43) Pub. Date: Jan. 29, 2026

(54) INFORMATION PROCESSING APPARATUS, INFORMATION PROCESSING METHOD, AND COMPUTER PROGRAM

(71) Applicant: SONY GROUP CORPORATION, TOKYO (JP)

(72) Inventors: KENJI SUZUKI, TOKYO (JP); TOYA TERAMOTO, TOKYO (JP)

(21) Appl. No.: 18/998,497

(22) PCT Filed: Jun. 6, 2023
(86) PCT No.: PCT/JP2023/021068

§ 371 Date: Jan. 25, 2025

(30) Foreign Application Priority Data
Aug. 3, 2022 (JP) 2022-124247

(51) Int. Cl. G06N 3/0464; G06T 11/00; G06V 10/74; G06V 10/771; G06V 20/70

(52) U.S. Cl. CPC G06N 3/0464; G06T 11/00; G06V 10/761; G06V 10/771; G06V 20/70

(57) ABSTRACT

Provided is an information processing apparatus that presents a determination basis of a machine-learned model on a concept basis. An information processing apparatus includes: a generation unit that generates a concept image identified in each stage of a machine learning model including a plurality of stages; an identification unit that identifies a contribution degree of a concept in each stage when the machine learning model processes an input image on a basis of activation of the concept image; and a presentation unit that presents a concept serving as a determination basis in each stage of the machine learning model on a basis of an identification result by the identification unit.

### TECHNICAL FIELD

The technology (hereinafter, “the present disclosure”) disclosed in this specification relates to an information processing apparatus, an information processing method, and a computer program that perform processing for presenting a determination basis of a machine learning model.

### BACKGROUND ART

With the evolution of machine learning, recognition, identification, prediction, and the like beyond humans have been realized. However, machine learning has a problem that it is unclear what is identified and determined as a determination basis. Therefore, visualizing or transparentizing the determination basis is important in eliminating bias of machine learning and improving accuracy of machine learning.

As a technique for visualizing a determination basis of a machine learning model, Grad-CAM (Gradient-weighted Class Activation Mapping) (see, e.g., NPL 1) and LIME (Local Interpretable Model-agnostic Explanations) (see, e.g., NPL 2.) have been developed. For example, the Grad-CAM is a technology of performing calculation based on a feature amount map obtained by calculation of a convolution layer or a pooling layer of a convolutional neural network (CNN) to display a characteristic area serving as a basis of classification in an input image on the input image. In addition, a method of calculating importance of a concept (that is, a concept that can be easily understood by humans) with respect to prediction of a trained model, such as TCAV (Testing with Concept Activation Vectors) (see, e.g., NPL 3), has also been developed.

### CITATION LIST

### Non-Patent Document

Non-Patent Document 1: Grad-CAM: Visual Explanations from Deep Networks via Gradient-based Localization <https://arxiv.org/abs/1610.02391>

Non-Patent Document 2: “Why Should I Trust You?”: Explaining the Predictions of Any Classifier <https://arxiv.org/abs/1602.04938>

Non-Patent Document 3: Interpretability Beyond Feature Attribution: Quantitative Testing with Concept Activation Vectors (TCAV) <https://arxiv.org/pdf/1711.11279.pdf>

Non-Patent Document 4: A. Radford, J. W. Kim, C. Hallacy, A. Ramesh, G. Goh, S. Agarwal, G. Sastry, A. Askell, P. Mishkin, J. Clark, G. Krueger, and I. Sutskever (2021) Learning transferable visual models from natural language supervision. In Proceedings of the 38th Conference International on Machine Learning, ICML 2021, 18-24 Jul. 2021, Virtual Event, M. Meila and T. Zhang (Eds.), Proceedings of Machine Learning Research, Vol. 139, pp. 8748-8763.

### SUMMARY OF THE INVENTION

### Problems to be Solved by the Invention

An object of the present disclosure is to provide an information processing apparatus, an information processing method, and a computer program that perform processing for presenting a determination basis of a machine learning model.

### Solutions to Problems

The present disclosure has been made in view of the above problems, and a first aspect thereof is an information processing apparatus including:
a generation unit that generates a concept image identified in each stage of a machine learning model including a plurality of stages;
an identification unit that identifies a contribution degree of a concept in each stage when the machine learning model processes an input image on a basis of activation of the concept image; and
a presentation unit that presents a concept serving as a determination basis in each stage of the machine learning model on a basis of an identification result by the identification unit.

The generation unit generates a plurality of concept images for each stage of the machine learning model, and groups the concept images into a concept image group on the basis of a concept. Then, the identification unit calculates a contribution degree of a corresponding concept on the basis of activation of each concept image group at each stage of the machine learning model.

The information processing apparatus according to the first aspect may further include a correction unit that corrects an identification result of the machine learning model by correcting activation of a concept image group corresponding to a concept for which a determination error has occurred.

Furthermore, a second aspect of the present disclosure is an information processing method including:
a generation step of generating a concept image identified in each stage of a machine learning model including a plurality of stages;
an identification step of identifying a contribution degree of a concept in each stage when the machine learning model processes an input image on a basis of activation of the concept image; and
a presentation step of presenting a concept serving as a determination basis in each stage of the machine learning model on a basis of an identification result in the identification step.

Furthermore, a third aspect of the present disclosure is a computer program described in a computer readable format to cause a computer to function as:
a generation unit that generates a concept image identified in each stage of a machine learning model including a plurality of stages;
an identification unit that identifies a contribution degree of a concept in each stage when the machine learning model processes an input image on a basis of activation of the concept image; and
a presentation unit that presents a concept serving as a determination basis in each stage of the machine learning model on a basis of an identification result by the identification unit.

The computer program according to the third aspect of the present disclosure defines a computer program described in a computer-readable format so as to implement predetermined processing on a computer. In other words, by installing the computer program according to the third aspect of the present disclosure in the computer, a cooperative operation is exhibited on the computer, and it is possible to produce effects similar to those produced by the information processing apparatus according to the first aspect of the present disclosure.

### Effects of the Invention

According to the present disclosure, it is possible to provide an information processing apparatus, an information processing method, and a computer program that perform processing for presenting a determination basis of a machine-learned model on a concept basis.

Note that the effects described in the present specification are merely examples, and the effects to be brought by the present disclosure are not limited thereto. Furthermore, there are cases where the present disclosure further provides some other effects, in addition to the effects described above.

Still other objects, features, and advantages of the present disclosure will become apparent from a more detailed description based on embodiments as described later and the accompanying drawings.

### BRIEF DESCRIPTION OF DRAWINGS

FIG. 1 is a diagram illustrating a functional configuration of an information processing apparatus 100.

FIG. 2 is a diagram illustrating a concept image generation example.

FIG. 3 is a diagram illustrating a presentation example of a contribution degree of a concept at each stage of a machine learning model 200.

FIG. 4 is a diagram illustrating a configuration of a convolutional neural network 400.

FIG. 5 is a diagram illustrating how a concept image generation unit 101 generates a concept image of the convolutional neural network 400.

FIG. 6 is a diagram illustrating a method of calculating a contribution degree of a concept using a linear discriminator.

FIG. 7 is a diagram illustrating a method of calculating a contribution degree of a concept using singular value decomposition.

FIG. 8 is a diagram illustrating a method of calculating a contribution degree of a concept by performing compressing processing on a concept image group.

FIG. 9 is a diagram illustrating a presentation example of a contribution degree of a concept at each stage of a convolutional neural network 400.

FIG. 10 is a diagram illustrating a configuration example of an information processing apparatus 2000.

FIG. 11 is a diagram illustrating a mechanism for performing labeling on an image using a CLIP model.

FIG. 12 is a diagram illustrating another example in which a determination basis of a model is presented on a multi-stage concept basis.

FIG. 13 is a diagram illustrating an operation example for instructing correction of a concept.

### MODE FOR CARRYING OUT THE INVENTION

Hereinafter, the present disclosure will be described in the following order with reference to the drawings.
A. Outline
B. Basic Configuration
C. Example
   C-1. Configuration of Convolutional Neural Network
   C-2. Generation of Concept Image
   C-3. Presentation of Concept
D. Hardware Configuration of Information Processing Apparatus

### A. Outline

As a technique for visualizing a determination basis of a machine learning model, Grad-CAM and LIME have been developed, but these are techniques for describing the determination basis on a pixel basis, and there is a problem that it is difficult for a human to understand. In addition, these pixel-based description methods are not suitable for real-time processing because gradient calculation basically needs to be performed. In addition, a method of presenting a determination basis on a concept basis such as TCAV is easy for humans to understand, but there is a possibility that different determination bases are indicated for each variation of a recognition target. For example, in a field such as movie analysis, an actor wears various outfits or applies makeup to increase variations of recognition targets, and thus, there is a possibility that a different determination basis is indicated when a scene of a movie changes.

Therefore, the present disclosure proposes a technology of presenting a concept serving as a determination basis of a machine learning model in multiple stages, that is, a technology of presenting a determination basis on a concept basis in each of a plurality of stages in a process in which the machine learning model recognizes, identifies, and predicts input data such as an image and a video.

According to the present disclosure, since a concept serving as a determination basis is presented in multiple stages from a general-purpose concept of a lower order layer of a machine learning model to a concept unique to high-dimensional identification, a user (analyst or the like) can confirm what kind of concept change has occurred in the machine learning model in a process of recognizing, identifying, and predicting input data.

According to the present disclosure, since the determination basis of the machine learning model is presented as a multi-stage concept, it is possible to present at which stage of the concept the machine learning model is different and whether or not the concept is configured at a correct stage. That is, according to the present disclosure, as compared with the method of simply presenting the importance of the concept with respect to the output label of the image classification (for example, the “zebra” class may have important stripes), by presenting with a multi-stage concept, the degree of dependence of the model is easy to understand, and the correction of the result with the concept is easy for a human to understand.

### B. Basic Configuration

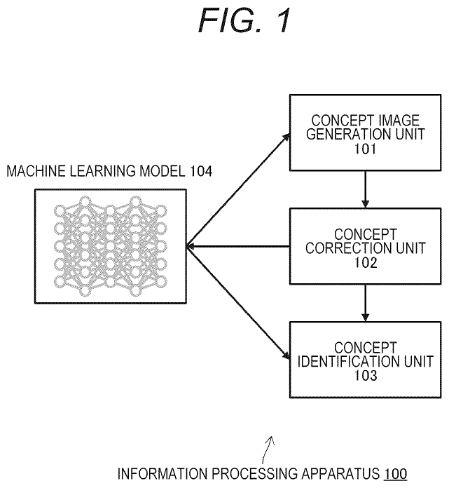

FIG. 1 schematically illustrates a functional configuration of an information processing apparatus 100 to which the present disclosure is applied. The information processing apparatus 100 performs processing for presenting a determination basis of a machine learning model. It is assumed that the machine learning model is learned in advance so as to mainly recognize, identify, or predict an input image (hereinafter, it is assumed that simply “recognition” is performed) (hereinafter, when referring to a “machine learning model”, it is assumed that the model has been learned unless otherwise specified). The process in which the machine learning model recognizes the input image includes a plurality of stages. The machine learning model to be processed by the information processing apparatus 100 is, for example, a convolutional neural network, but may be, of course, a neural network of another form or a machine learning model including various configurations other than the neural network. Then, the information processing apparatus 100 performs processing for identifying and presenting the determination basis in each of the plurality of stages of the machine learning model on a concept basis.

The information processing apparatus 100 illustrated in FIG. 1 includes functional modules of a concept image generation unit 101, a concept correction unit 102, and a concept identification unit 103. Each of the functional modules 101 to 103 can be realized, for example, in a form of executing a predetermined computer program on a personal computer (PC). Furthermore, the information processing apparatus 100 may be configured by one apparatus, or may be configured by combining a plurality of apparatuses. For example, each functional module may be constituted by one apparatus, or some functional modules may be implemented on a cloud.

The concept image generation unit 101 generates a plurality of images (hereinafter, also referred to as a “concept image”) representing the identified concept in each of a plurality of stages in which the machine learning model 104 recognizes the input image. For example, the concept image generation unit 101 may input a random image to the machine learning model and generate a concept image on the basis of the feature map generated at each stage of the machine learning model 104. Furthermore, the concept image generation unit 101 performs labeling on the basis of each generated concept image with a text (word) representing a concept, and groups the concept images into a concept image group on the basis of the label.

For example, the concept image generation unit 101 may perform labeling on the concept image using a CLIP (Contrastive Language-Image Pre-training) model (see, e.g., NPL 4) in which a data set including a combination of texts of a huge amount of images is learned. Of course, the concept image generated by the concept image generation unit 101 may be labeled by a manual input of a user (for example, a designer of the information processing apparatus 100).

The concept correction unit 102 performs modification on the machine learning model 104 at a concept level. For example, in a case where the final recognition result for the input image of the machine learning model 104 is failure, the user (for example, an analyst of a machine learning model or an input image) can determine at which stage of the machine learning model 104 there is an error in the concept identification on the basis of the identification result by the concept identification unit 103 described later. In such a case, the concept correction unit 102 corrects the concept of the machine learning model 104 by giving a correction vector so as to suppress the activation of the concept determined as an error (alternatively, set the activation to 0).

The concept identification unit 103 calculates a contribution degree of a concept to an output (final recognition result) of the machine learning model 104 at each stage of the machine learning model 104. According to the present disclosure, the concept identification unit 103 can calculate a contribution degree of a corresponding concept on the basis of activation of a concept image group when the machine learning model 104 recognizes an input image.

For example, the concept identification unit 103 inputs an input image to the machine learning model 104 to a linear discriminator configured by each concept image group generated for each stage, and calculates a contribution degree of a concept in each stage of the machine learning model 104 on the basis of an output of each linear discriminator. The linear discriminator is, for example, a support vector machine (SVM), and discriminates whether or not the input image belongs to a concept image group.

Alternatively, the concept identification unit 103 performs singular value decomposition (SVD) on each concept image group generated for each stage of the machine learning model 104 and the feature map of the input image to obtain a “concept important vector” including a singular vector and the like, and calculates a contribution degree of a concept in each stage of the machine learning model 104 on the basis of cosine similarity of the concept important vector between the concept image group and the input image.

In addition, the concept identification unit 103 can speed up the calculation processing of the contribution degree of the concept by using the concept compressed image group obtained by compressing each concept image group generated for each stage of the machine learning model 104 in a method using either the linear discriminator or the SVM.

Then, the concept identification unit 103 presents the contribution degree of each concept calculated for each stage using a graphical user interface (GUI) of a computer or the like. Therefore, the user (for example, an analyst of a machine learning model or an input image) can confirm how a concept change has occurred in the machine learning model 104 from a low-dimensional general-purpose concept to a concept unique to high-dimensional identification on the basis of the contribution degree of the concept presented step by step on a GUI screen. In addition, in a case where the recognition result for the input image of the machine learning model 104 is failure (alternatively, in a case where the recognition result of the machine learning model 104 is not satisfactory), it is easy to determine the cause of contribution of the concept identification to the recognition error of the machine learning model 104 at which stage among the plurality of stages.

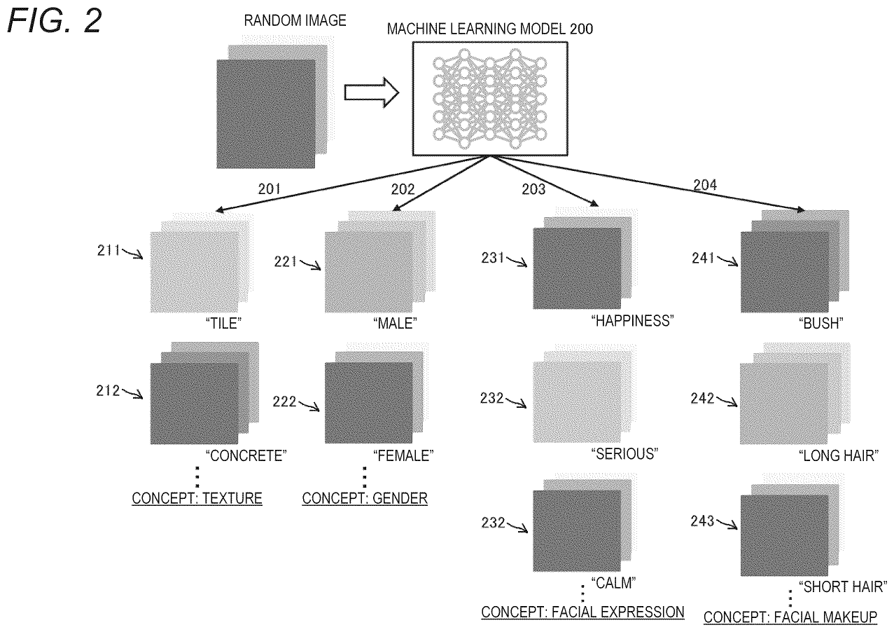

FIG. 2 schematically illustrates a concept image generation example by the concept image generation unit 101. In the illustrated example, the machine learning model 200 that performs image recognition such as face identification is set as a processing target. It is assumed that the process in which the machine learning model 200 performs face identification includes four stages 201 to 204. The concept image generation unit 101 inputs a random image to the machine learning model 200 and generates a concept image of each of the stages 201 to 204 on the basis of the feature map generated in each of the stages 201 to 204 of the machine learning model 200. However, in FIG. 2, for convenience, each concept image is simply drawn as an image of one color having different shades, but it should be understood that the concept image is actually an image having a complicated picture pattern or pattern.

In the example shown in FIG. 2, the concept identified in the first stage 201 of the machine learning model 200 is texture. Therefore, the concept image generation unit 101 groups a large number of concept images generated from the random images in the first stage 201 of the machine learning model 200 on the basis of a concept regarding texture to generate a plurality of concept image groups 211, 212, . . . Specifically, the concept image generation unit 101 performs labeling representing a concept of texture such as “tile”, “concrete”, “brick”, “wood grain”, “fabric”, “gravel”, . . . on each concept image generated from the random image in the first stage 201 of the machine learning model 200 using, for example, the CLIP model (described above), and groups the concept images into a plurality of concept image groups 211, 212, . . . on the basis of the label.

In addition, in the example illustrated in FIG. 2, the concept identified in the second stage 202 of the machine learning model 200 is gender. Therefore, the concept image generation unit 101 groups a large number of concept images generated from the random images in the second stage 202 of the machine learning model 200 on the basis of the concept regarding gender to generate a plurality of concept image groups 221, 222, . . . Specifically, the concept image generation unit 101 performs labeling representing a concept of gender such as “male”, “female”, . . . on each concept image generated from the random image in the second stage 202 of the machine learning model 200 using, for example, the CLIP model (described above), and groups the concept images into a plurality of concept image groups 221, 222, . . . on the basis of the label.

Furthermore, in the example illustrated in FIG. 2, the concepts identified in the third stage 203 of the machine learning model 200 are emotion and facial expression. Therefore, the concept image generation unit 101 groups a large number of concept images generated from the random images in the third stage 203 of the machine learning model 200 on the basis of concepts regarding emotion and facial expression to generate a plurality of concept image groups 231, 232, . . . Specifically, the concept image generation unit 101 performs labeling representing concepts of emotion and facial expression such as “happiness”, “serious”, “calm”, “crying”, . . . on each concept image generated from the random image in the third stage 203 of the machine learning model 200 using, for example, the CLIP model (described above), and groups the concept images into a plurality of concept image groups 231, 232, . . . on the basis of the label.

Furthermore, in the example illustrated in FIG. 2, the concept identified in the fourth stage 204 of the machine learning model 200 is makeup. Therefore, the concept image generation unit 101 groups a large number of concept images generated from the random images in the fourth stage 204 of the machine learning model 200 on the basis of a concept regarding makeup to generate a plurality of concept image groups 241, 242, . . . Specifically, the concept image generation unit 101 performs labeling representing a concept of makeup such as “beard”, “long hair”, “short hair”, “cheek”, . . . on each concept image generated from the random image in the fourth stage 204 of the machine learning model 200 using, for example, the CLIP model (described above), and groups the concept images into a plurality of concept image groups 241, 242, . . . on the basis of the label.

The concept identification unit 103 calculates a contribution degree of the concept in each stage to the recognition result of the input image of the machine learning model 200 and presents the contribution degree of the concept for each stage. Specifically, in each of steps 201 to 204, the concept identification unit 103 calculates the contribution degree of each concept image to the recognition result of the machine learning model 200 using the linear identifier and the singular value decomposition (described above), and presents the contribution degree using a GUI of a computer or the like.

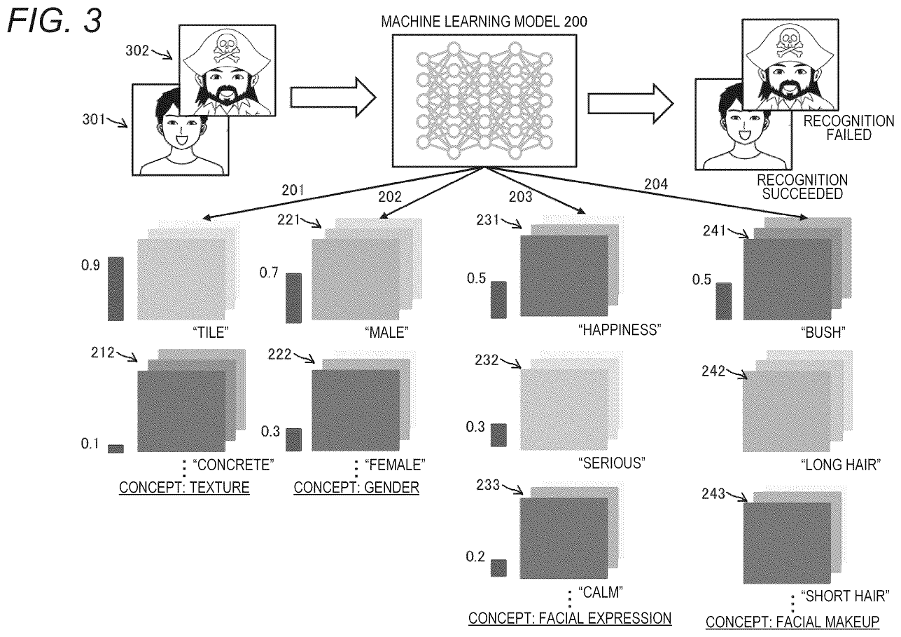

FIG. 3 illustrates a presentation example of the contribution degree of the concept at each stage with respect to the recognition result of the input image 302 of the machine learning model 200 by the concept identification unit 103. The information processing apparatus 100 presents a screen including information on the contribution degree of each concept as illustrated in FIG. 3 using, for example, a GUI of a computer. Here, a case where the machine learning model 200 fails in recognition of the image 302 when the same movie actor performs the makeup of a pirate in a play is taken as an example on the assumption that recognition of a normal face photograph 301 of a certain movie actor succeeds.

In the first stage 201 of the machine learning model 200, the concept identification unit 103 calculates and presents the contribution degree of the concept image 211 of “tile” and the concept image 212 of “concrete” regarding the concept “texture” as 0.9:0.1. Furthermore, in the second stage 202 of the machine learning model 200, the concept identification unit 103 calculates and presents the contribution degree of the concept image 221 of “male” and the concept image 222 of “female” regarding the concept “gender” as 0.7:0.3. Furthermore, in the third stage 203 of the machine learning model 200, the concept identification unit 103 calculates and presents the contribution degree of the concept image 231 of “happiness”, the concept image 232 of “earnest”, and the concept image 233 of “calm” regarding the concept “facial expression” as 0.5:0.3:0.2. Furthermore, in the fourth stage 204 of the machine learning model 200, the concept identification unit 103 calculates and presents the contribution degree of the concept image 241 . . . of “whisker” regarding the concept “makeup” as 0.5: . . .

As illustrated in FIG. 3, the concept identification unit 103 can present a concept serving as a determination basis in multiple stages from general-purpose concepts “texture” and “gender” of the lower order layer in the stages 201 to 202 of the machine learning model 200 to a concept “makeup” unique to high-dimensional identification in the stage 204. Therefore, the user (for example, the analyst of the input image 302) can confirm what kind of concept change has occurred in the machine learning model 200 in the recognition process of the input image 302. Then, the user can determine at which stage of the machine learning model 200 an error has occurred in the concept identification on the basis of the multi-stage identification result by the concept identification unit 103 as illustrated in FIG. 3.

In a case where the machine learning model 200 fails to recognize the image 302 of the movie actor who has applied the makeup of a pirate in the play, the user determines, on the basis of presentation of the determination basis on a concept basis as illustrated in FIG. 3, that the recognition error is caused by the fact that the contribution degree of the concept image 241 of “bush” is too high (that is, when the input image 302 is recognized, “bush” is overestimated) when the machine learning model 200 identifies the concept “makeup” in the fourth stage 204. In such a case, the concept correction unit 102 corrects the concept of the machine learning model 200 by providing a correction vector for suppressing the activation of the concept image 241 of the “bush” (alternatively, setting the activation to 0) on the basis of a correction instruction from the user. Thereafter, in a case where a similar image is input to the machine learning model 200, in the fourth stage 204, the activation of the concept corresponding to the concept image 241 of the “bush” is suppressed and does not propagate to the recognition process in the subsequent stage, so that a similar recognition error does not occur.

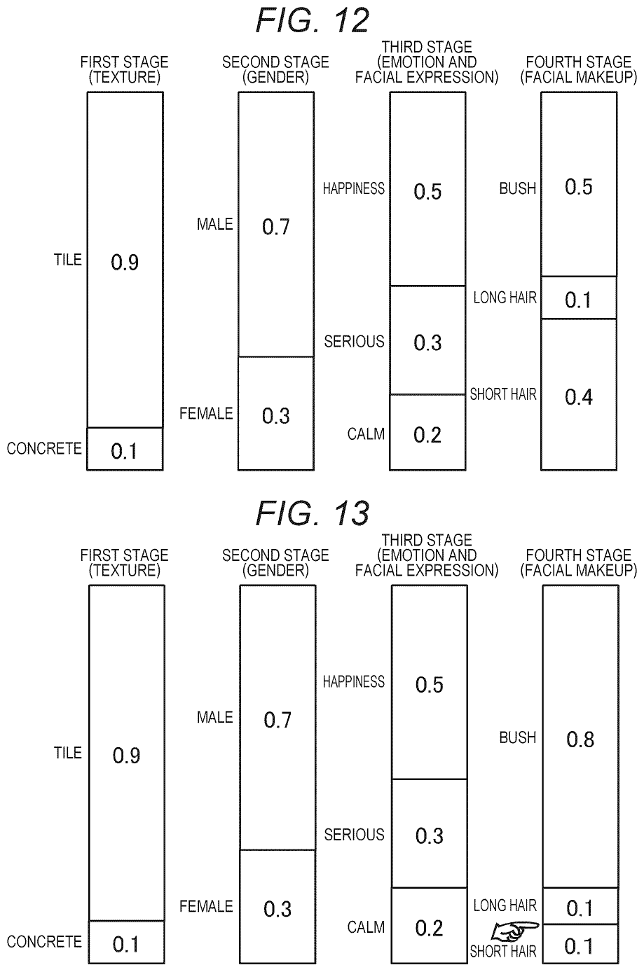

FIG. 12 illustrates another presentation example of the contribution degree of the concept at each stage of the machine learning model 200 by the concept identification unit 103. When the user understands the determination basis of the machine learning model 200 on a multi-stage concept basis, it is not always necessary to understand what kind of concept image group is at each stage of the machine learning model 200. In the presentation example of the contribution degree of the concept illustrated in FIG. 12, detailed and complicated information such as a concept image is omitted, and the specific gravity of the contribution degree of the concept for each stage of the machine learning model 200 is displayed on, for example, a GUI screen. Therefore, the user confirms the determination basis when the machine learning model 200 performs the recognition processing on the input image on a multi-stage concept basis, and easily understands what kind of concept change has occurred in the machine learning model 200. In addition, when the machine learning model 200 fails in recognition, the user can discover the cause on a multi-stage concept basis. For example, the user can easily find, from the GUI screen, that the recognition error is caused by an excessively high contribution degree of the concept “short hair” in the fourth stage of the machine learning model 200. Furthermore, for example, as illustrated in FIG. 13, the user can perform a GUI operation of reducing the area of the “short hair” by dragging the cursor downward after placing the cursor on the boundary between the concepts “long hair” and “short hair”, and input an instruction to the concept correction unit 102 to suppress the activation of the concept “short hair” in the fourth stage.

### C. Example

An example of a machine learning model is a convolutional neural network (CNN). In this item C, a configuration of a convolutional neural network to which the present disclosure is applied and a specific operation for the information processing apparatus 100 to present a determination basis of the convolutional neural network on a concept basis will be described.

### C-1. Configuration of Convolutional Neural Network

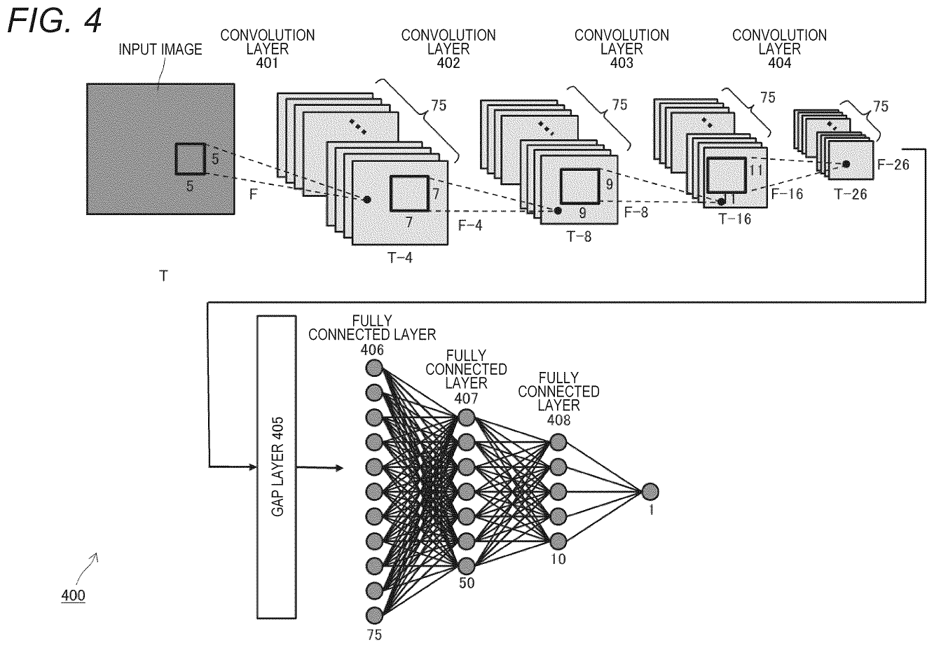

FIG. 4 schematically illustrates a configuration of a convolutional neural network to which the present disclosure is applied. The illustrated convolution neural network 400 includes four convolution layers 401 to 404, a global average pooling (GAP) layer 405, and three fully connected layers (affine layers) 406 to 408. The four convolution layers 401 to 404 and the GAP layer 405 correspond to a “feature extraction unit” that extracts a feature amount of the input image, and the fully connected layers 406 to 408 correspond to an “identification unit” that identifies a class of the input image on the basis of the feature amount extracted by the feature extraction unit in the preceding stage.

In the first convolution layer 401, a plurality of types of filters (in the example illustrated in FIG. 4, 75 types of 5×5 filters) is convolved with respect to the input image, and convolution results of the same filter position are added (simple addition or weighted addition may be used) to generate a plurality of feature maps (in the example illustrated in FIG. 4, 75(F-4)×(T-4) feature maps).

Next, in the second convolution layer 402, a plurality of types of filters (in the example illustrated in FIG. 4, 7×7 filters) is further convolved with respect to each feature map generated in the first convolution layer 401 to generate a plurality of feature maps (in the example illustrated in FIG. 4, 75(F-8)×(T-8) feature maps). Next, in the third convolution layer 403, a plurality of types of filters (in the example illustrated in FIG. 4, 9×9 filters) is further convolved with respect to each feature map generated in the second convolution layer 402 to generate a plurality of feature maps (in the example illustrated in FIG. 4, 75(F-16)×(T-16) feature maps). Furthermore, in the fourth convolution layer 404, a plurality of types of filters (in the example illustrated in FIG. 4, 11×11 filters) is further convolved with respect to each feature map generated in the third convolution layer 403 to generate a plurality of feature maps (in the example illustrated in FIG. 4, 75(F-26)×(T-26) feature maps).

The GAP layer 405 calculates an average of all element values on each feature map and replaces only the average value. That is, by this operation, conversion into one vector having the number of dimensions of depth (75 dimensions in the example illustrated in FIG. 4) is performed.

Here, the four convolution layers 401 to 404 correspond to four stages 201 to 204 (see FIG. 2) for performing face identification, respectively. Therefore, the two convolution layers 401 to 402 in the preceding stage perform feature extraction regarding a general-purpose concept of the lower order layer, and the two convolution layers 403 to 404 in the subsequent stage perform feature extraction regarding a high-dimensional concept.

The number of elements of the three fully connected layers (affine layers) 406 to 408 is 75, 50, and 10 (however, in FIG. 4, the number of elements of each layer is thinned out in order to prevent the illusion of the drawing). Each of the fully connected layers 406 to 408 is configured such that all elements of each layer are connected to all elements of subsequent layers. The last one value that is the output of the fully connected layer 408 is the output label of the convolutional neural network 400.

Note that the configuration of the convolutional neural network 400 illustrated in FIG. 4 actually represents a function of the convolutional neural network 400 realized by executing a software program on a central processing unit (CPU), or a graphics processing unit (GPU) or general-purpose computing on graphics processing units (GPGPU) capable of performing faster processing.

### C-2. Generation of Concept Image

Each of the convolution layers 401 to 404 constituting the feature extraction unit of the convolutional neural network 400 illustrated in FIG. 4 corresponds to each of the stages 201 to 204 (see FIG. 2) of the machine learning model illustrated in FIG. 2. Each of the convolution layers 401 to 404 respectively convolutes a filter to generate a feature map from which features of the input image are extracted, but it is empirically known that in practice, concepts of the input image are extracted step by step from a generic concept of a lower order layer to a concept unique to high-dimensional identification.

The concept image generation unit 101 generates a concept image representing a concept identified in each of the convolution layers 401 to 404 of the convolutional neural network 400. In the present example, the concept image generation unit 101 inputs a large number of random images to the convolutional neural network 400, and generates a concept image of each of the convolution layers 401 to 404 on the basis of the feature map generated in each of the convolution layers 401 to 404.

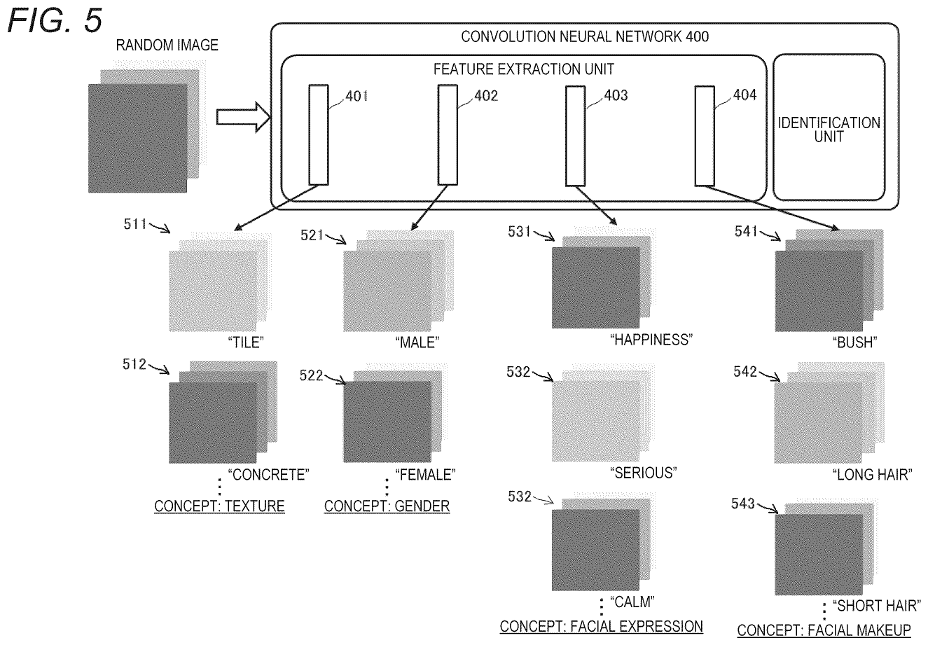

FIG. 5 schematically illustrates a state in which the concept image generation unit 101 generates a concept image group of each of the convolution layers 401 to 404 of the convolution neural network 400 from a random image. However, in FIG. 5, each concept image is drawn in a simplified manner for convenience. A concept image group generated by the convolution layers 401 and 402 in the preceding stage is an image representing general-purpose concepts “texture” and “gender” of the lower order layer. Furthermore, a concept image group generated by the convolution layers 403 and 404 on the subsequent stage is an image representing concepts “facial expression” and “makeup” unique to high-dimensional identification. However, in FIG. 5, for convenience, each concept image is simply drawn as an image of one color having different shades, but it should be understood that the concept image is actually an image having a complicated picture pattern or pattern.

Furthermore, the concept image generation unit 101 performs labeling on each generated concept image with a text (word) representing a concept. In the present example, the concept image generation unit 101 may perform labeling on the concept image using the CLIP model (described above). The CLIP model is an example of a VL (Vision-Language) model, and is a multimodal base model that connects language and image data. The CLIP model has a text encoder and an image encoder each having a function (Embedding) of mapping a language and an image to the same vector representation on a common vector space.

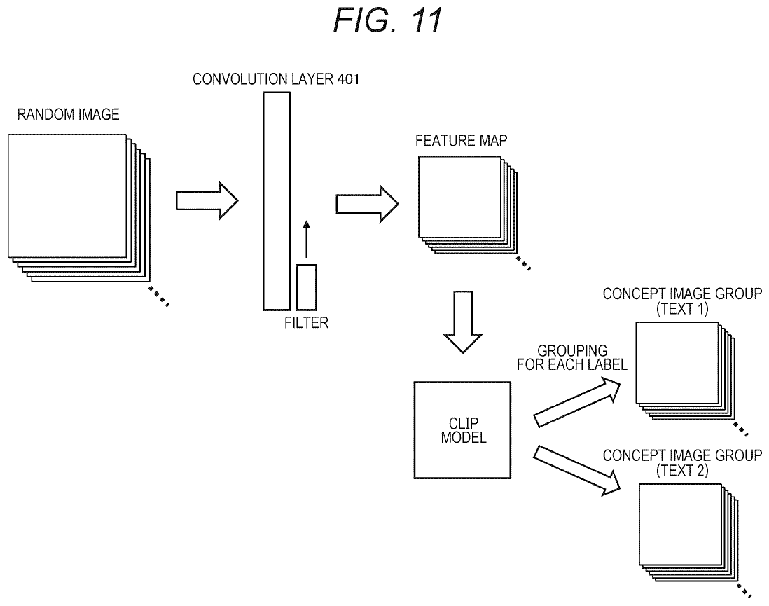

FIG. 11 schematically illustrates a mechanism for performing labeling on an image using the CLIP model. In a general learning model such as the convolutional neural network 400, a feature extraction unit that extracts a feature of an image and an identification unit that predicts a label of a feature amount are jointly learned. On the other hand, the CLIP model is obtained by jointly learning the image encoder and the text encoder so as to predict the correct combination of the image and the text. As illustrated in FIG. 11, when a large number of random images are input, a large number of feature maps output from the convolution layer 401 can be labeled using a CLIP model (more precisely, a text encoder of the CLIP model). The label given here is a text that means a concept of a feature map as a concept image. Then, by sorting each feature map on the basis of labels or concepts attached by the CLIP model, the feature maps are grouped into concept image groups for each concept. The feature maps output from the convolution layers 402 to 404 in the subsequent stage are similarly grouped into a plurality of concept image groups on the basis of the label attached by the CLIP model. In the present example, in each layer, that is, each stage of the convolution layers 401 to 404, labeling is performed on the concept image with a text meaning the concept using the CLIP model.

Referring again to FIG. 5, the concept identified in the first convolution layer 401 of the convolutional neural network 400 is “texture”. Therefore, the concept image generation unit 101 groups a large number of feature maps generated from the random images in the first convolution layer 401 of the convolutional neural network 400 on the basis of a concept regarding texture to generate a plurality of concept image groups 511, 512, Specifically, the concept image generation unit 101 performs labeling representing a concept of texture such as “tile”, “concrete”, “brick”, “wood grain”, “fabric”, “gravel”, . . . on each feature map generated from the random image in the first convolution layer 401 of the convolutional neural network 400, using, for example, the CLIP model (described above), and groups the feature maps into a plurality of concept image groups 511, 512, . . . on the basis of the label.

Furthermore, in the example illustrated in FIG. 5, the concept identified by the second convolution layer 402 of the convolutional neural network 400 is “gender”. Therefore, the concept image generation unit 101 groups a large number of feature maps generated from the random images in the second convolution layer 402 of the convolutional neural network 400 on the basis of a concept regarding gender to generate a plurality of concept image groups 521, 522,. Specifically, the concept image generation unit 101 performs labeling representing a concept regarding gender such as “male”, “female”, . . . on each feature map generated from the random image in the second convolution layer 402 of the convolutional neural network 400, using, for example, the CLIP model (described above), and groups the feature maps into a plurality of concept image groups 521, 522, . . . on the basis of the label.

Furthermore, in the example illustrated in FIG. 5, the concept identified by the third convolution layer 403 of the convolutional neural network 400 is “emotion and facial expression”. Therefore, the concept image generation unit 101 groups a large number of feature maps generated from the random images in the third convolution layer 403 of the convolutional neural network 400 on the basis of a concept regarding emotion and facial expression to generate a plurality of concept image groups 531, 532, Specifically, the concept image generation unit 101 performs labeling representing concepts of emotion and facial expression such as “happiness”, “serious”, “calm”, “crying”, . . . using, for example, the CLIP model (described above) on each feature map generated from the random image in the third convolution layer 403 of the convolutional neural network 400, and groups the feature maps into a plurality of concept image groups 531, 532, . . . on the basis of the label.

Furthermore, in the example illustrated in FIG. 5, the concept identified by the fourth convolution layer 404 of the convolutional neural network 400 is “makeup”. Therefore, the concept image generation unit 101 groups a large number of feature maps generated from the random images in the fourth convolution layer 404 of the convolutional neural network 400 on the basis of a concept regarding makeup to generate a plurality of concept image groups 541, 542, Specifically, the concept image generation unit 101 performs labeling representing a concept regarding makeup such as “beard”, “long hair”, “short hair”, “cheek”, . . . on each feature map generated from the random image in the fourth convolution layer 404 of the convolutional neural network 400 using, for example, the CLIP model (described above), and groups the feature maps into a plurality of concept image groups 541, 542, . . . on the basis of the label.

### C-3. Presentation of Concept

The concept identification unit 103 calculates a contribution degree of a concept in each of the convolution layers 401 to 404 to a final recognition result of the convolution neural network 400, and presents the calculated contribution degree of the concept.

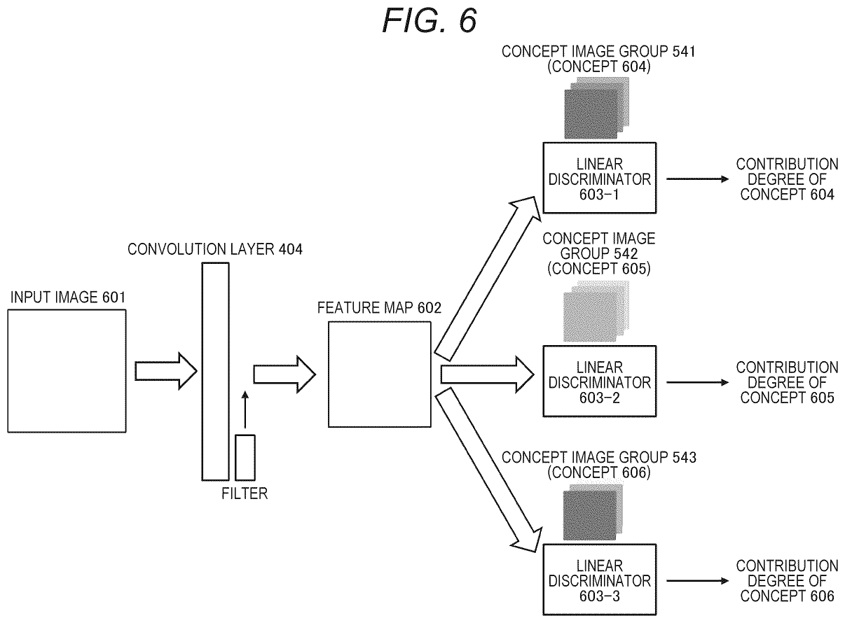

One method of calculating the contribution degree of the concept by the concept identification unit 103 is a method using a linear discriminator. FIG. 6 illustrates a method of calculating the contribution degree of each concept of the fourth convolution layer 404 to the recognition result of the convolution neural network 400 for an input image 601 using a linear discriminator.

First, the input image 601 is input to the convolution neural network 400, a feature map 602 is generated in the fourth convolution layer 404, the feature map 602 is input to a linear discriminator 603 configured by a concept image, and the contribution degree of the concept is calculated on the basis of the output of the linear discriminator 603. In the example illustrated in FIG. 6, each of the concept image groups 541 to 543 generated in the fourth convolution layer 404 constitutes a linear discriminator 603-1, a linear discriminator 603-2, and a linear discriminator 603-3. Each of the linear discriminators 603-1 to 603-3 is, for example, an SVM, and can calculate a contribution degree of the concepts 604 to 606 corresponding to each of the concept image groups 541, 542, . . . on the basis of a result of determining whether or not the feature map 602 belongs to each of the concept image groups 604 to 606. Note that, although illustration and description are omitted, in the other convolution layers 401 to 403, the contribution degree of the concept in each stage can be calculated according to a procedure similar to that in FIG. 6.

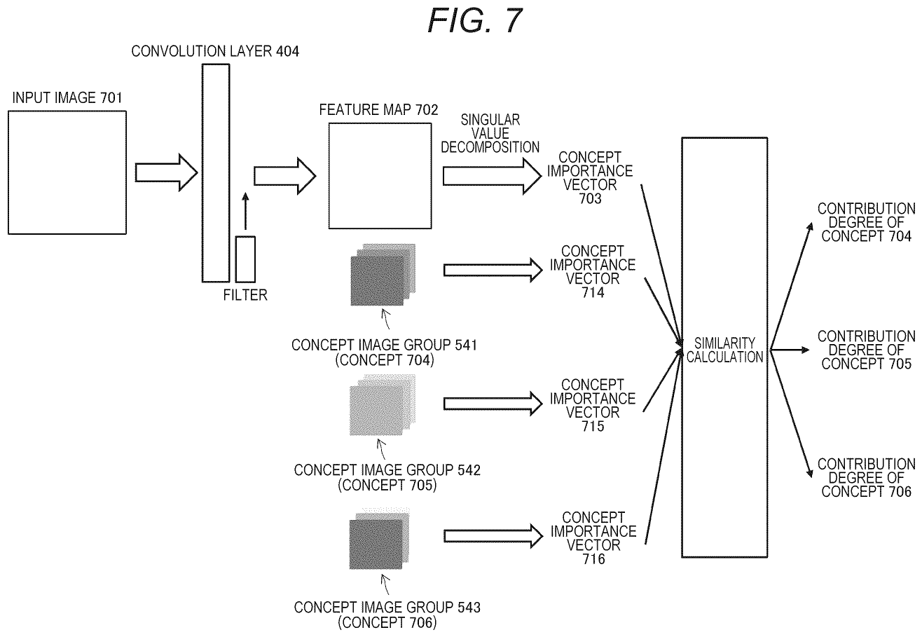

In a case where the contribution degree of each concept is calculated using the linear discriminator, there is a problem that the amount of calculation is large and real-time processing is difficult. Therefore, as a method in which the concept identification unit 103 performs real-time processing of calculation of a contribution degree of a concept, there is a method of determining a direction of a concept of an input image by singular value decomposition or the like on the basis of activation of a concept image. FIG. 7 illustrates a method of calculating the contribution degree of each concept of the fourth convolution layer 404 to the recognition result of the convolution neural network 400 for an input image 701 on the basis of the activation of the concept image.

First, the input image 701 is input to the convolution neural network 400, and a feature map 702 of the input image 701 is generated in the fourth convolution layer 404. The feature map 702 is subjected to singular value decomposition to obtain a “concept importance vector” 703 such as a singular vector. In addition, concept important vectors 714 to 716 are acquired as directions 704 to 706 of each concept by singular value decomposition on the basis of the activation of each of the concept image groups 541, 542, . . . of the fourth convolution layer 404. Then, the contribution degree of each of the concepts 704 to 706 to the input image 701 is calculated on the basis of the cosine similarity between the concept important vectors of the concept image groups 541, 542,. Note that, although illustration and description are omitted, also in the other convolution layers 401 to 403, the contribution degree of each concept can be calculated according to a procedure of similarly acquiring a concept importance vector by singular value decomposition and calculating cosine similarity.

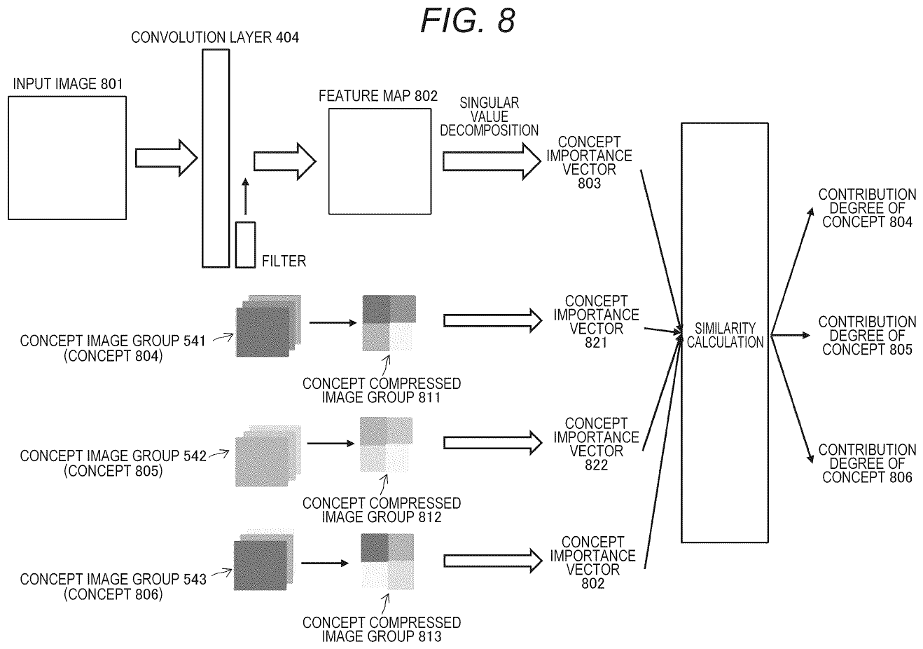

According to the calculation method using the singular value decomposition illustrated in FIG. 7, real-time processing of concept contribution degree calculation can be realized. In order to further increase the speed, there is a calculation method of compressing a concept image group. FIG. 8 illustrates a method of compressing each of the concept image groups 541, 542, . . . of the fourth convolution layer 404 and calculating a contribution degree of each concept.

First, each of the concept image groups 541, 542, . . . of the fourth convolution layer 404 is compressed to generate concept compressed image groups 811 to 813 including one frame for each concept. Specifically, the compression of each of the concept image groups 541, 542, . . . is realized by pasting the concept images on one plane for each concept image group and treating the concept image group as one image frame. Next, concept importance vectors 821 to 823 as a direction of each of concepts 804 to 806 is acquired by singular value decomposition on the basis of the activation of each of the concept compressed image groups 811 to 813. In addition, the input image 801 is input to the convolution neural network 400, and a feature map 802 of the input image 801 is generated in the fourth convolution layer 404. The feature map 802 is subjected to singular value decomposition to obtain a concept important vector 803 such as a singular vector. Then, on the basis of cosine similarity between the concept important vector 803 obtained from the feature map 802 of the input image 801 and each of the concept important vectors 821 to 823 obtained from each of the concept compressed image groups 811 to 813, a contribution degree of each of the concepts 804 to 806 to the input image 801 is calculated. Note that, although illustration and description are omitted, also in the other convolution layers 401 to 403, the contribution degree of each concept can be calculated according to a procedure of similarly performing compression processing on a concept image group and calculating cosine similarity between concept important vectors.

Then, regardless of which method illustrated in FIGS. 6 to 8 is used, the concept identification unit 103 presents the contribution degree of each concept calculated in each of the convolution layers 401 to 404 using a GUI of a computer or the like.

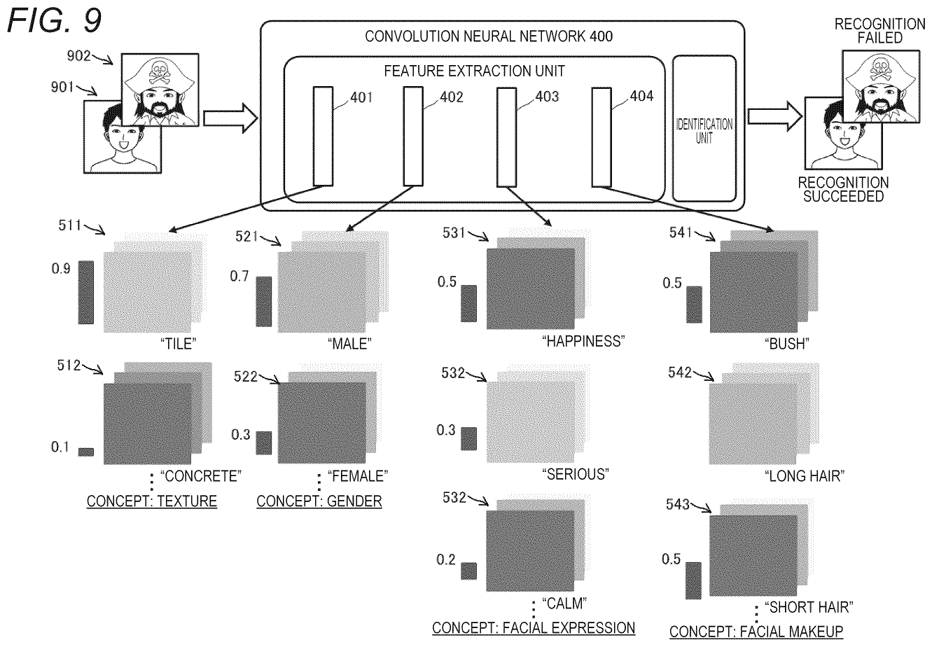

FIG. 9 illustrates a presentation example of the contribution degree of the concept in each of the convolution layers 401 to 404 by the concept identification unit 103. The information processing apparatus 100 presents a screen including information on the contribution degree of each concept as illustrated in FIG. 9 using, for example, a GUI of a computer. Here, a case where the convolutional neural network 400 fails in recognition of an image 902 when the same movie actor performs the makeup of a pirate in a play is taken as an example on the assumption that recognition of a normal face photograph 901 of a certain movie actor succeeds.

In the convolution layer 401, the concept identification unit 103 calculates and presents the contribution degree of the concept image 511 of “tile” and the concept image 512 of “concrete” regarding the concept “texture” as 0.9:0.1. Furthermore, in the convolution layer 402, the concept identification unit 103 calculates and presents the contribution degree of the concept image 521 of “male” and the concept image 522 of “female” regarding the concept “gender” as 0.7:0.3. Furthermore, in the convolution layer 403, the concept identification unit 103 calculates and presents the contribution degree of each of the concept images 531 to 533 of “happiness”, “serious”, and “calm” regarding the concept “facial expression” as 0.5:0.3:0.2. Furthermore, in the convolution layer 404, the concept identification unit 103 calculates and presents the contribution degree of each of the concept image 541 . . . of “whisker” . . . regarding the concept “makeup” as 0.5: . . .

As illustrated in FIG. 9, the concept identification unit 103 can present a concept serving as a determination basis in multiple stages from general-purpose concepts “texture” and “sex” of the lower order layer in the feature extraction unit of the convolutional neural network 400 to concepts “facial expression” and “makeup” unique to high-dimensional identification. Therefore, the user (for example, the analyst of the input image) can confirm how a concept change has occurred in the machine learning model from a low-dimensional general- purpose concept to a concept unique to high-dimensional identification on the basis of the contribution for each concept presented for each of the convolution layers 401 to 404. Furthermore, in a case where the recognition result for the input image of the convolutional neural network 400 is a failure (alternatively, in a case where the recognition result of the machine learning model is not satisfactory), it is easy to determine the cause of contribution of the concept identification to the recognition error of the machine learning model at which stage among the plurality of stages.

In a case where the convolutional neural network 400 has failed to recognize an image of a movie actor who has performed makeup of a pirate in a play, it is assumed that the user determines, on the basis of presentation of a determination basis on a concept basis as illustrated in FIG. 9, that the recognition error is caused by the fact that an excessively high contribution degree of the concept image 543 (concept “short hair”) in the convolution layer 404 which is a higher layer of the convolutional neural network 400. In such a case, the concept correction unit 102 corrects the concept of the convolutional neural network 400 by providing a correction vector for suppressing activation of the concept image 543 (concept “short hair”) (alternatively, setting the activation to 0). Thereafter, in a case where a similar image is input to the convolution neural network 400, activation of a concept corresponding to the concept image 543 is suppressed in the convolution layer 404 and is not propagated to the subsequent stage, so that a similar recognition error does not occur.

The concept identification unit 103 may present the contribution degree of a concept in each convolution layer of the convolutional neural network 400 in a screen configuration as illustrated in FIG. 12. When the user understands the determination basis of the convolutional neural network 400 on a multi-stage concept basis, it is not always necessary to understand what kind of concept image group is at each stage of the convolutional neural network 400. In the presentation example of the contribution degree of the concept illustrated in FIG. 12, detailed and complicated information such as a concept image is omitted, and the specific gravity of the contribution degree of the concept for each stage of the convolutional neural network 400 is displayed on the screen. Therefore, the user confirms the determination basis when the convolutional neural network 400 performs the recognition processing on the input image on a multi-stage concept basis, and easily understands what kind of concept change has occurred in the convolutional neural network 400. Furthermore, when the convolutional neural network 400 fails in recognition, the user can discover the cause on a multi-stage concept basis. For example, in the fourth convolution layer 404 of the convolutional neural network 400, the user can easily find that the recognition error is caused by the fact that the contribution degree of the concept “short hair” is too high. Furthermore, the user can perform a GUI operation for suppressing activation of the concept “short hair” on the screen at the fourth stage as illustrated in FIG. 13, for example, and input an instruction to the concept correction unit 102.

### D. Hardware Configuration of Information Processing Apparatus

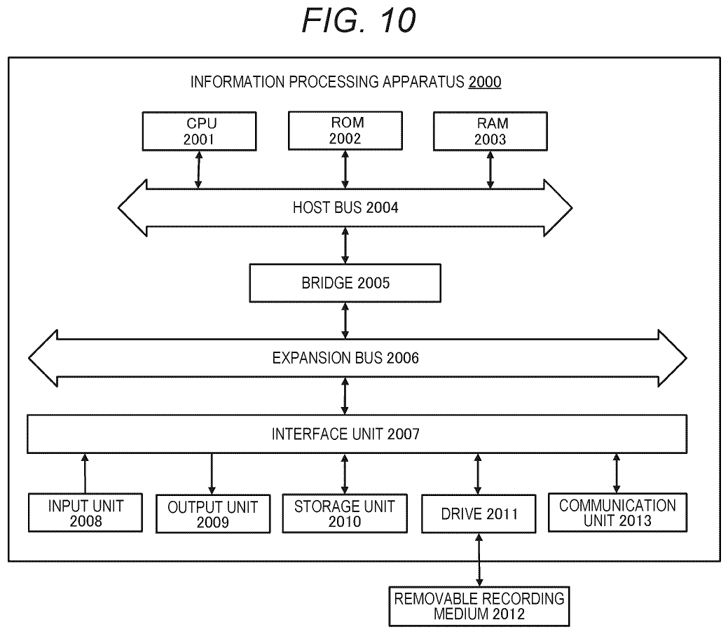

FIG. 10 illustrates a specific hardware configuration example of the information processing apparatus 100 illustrated in FIG. 1. The information processing apparatus 2000 illustrated in FIG. 10 includes, for example, a PC or the like.

The information processing apparatus 2000 illustrated in FIG. 10 includes a CPU 2001, a read only memory (ROM) 2002, a random access memory (RAM) 2003, a host bus 2004, a bridge 2005, an expansion bus 2006, an interface unit 2007, an input unit 2008, an output unit 2009, a storage unit 2010, a drive 2011, and a communication unit 2013.

The CPU 2001 functions as an arithmetic processing device and a control device, and controls the overall operation of the information processing apparatus 2000 according to various programs. The ROM 2002 stores programs (a basic input/output system, or the like) and calculation parameters used by the CPU 2001 in a nonvolatile manner. The RAM 2003 is used to load a program to be used in execution of the CPU 2001 and temporarily store parameters such as work data that appropriately changes during program execution. Examples of the program loaded into the RAM 2003 and executed by the CPU 2001 include various application programs, an operating system (OS), and the like.

The CPU 2001, the ROM 2002, and the RAM 2003 are interconnected by the host bus 2004 including a CPU bus or the like. Then, the CPU 2001 operates in conjunction with the ROM 2002 and the RAM 2003 to execute various application programs under the execution environment provided by the OS, thereby enabling various functions and services to be implemented. In a case where the information processing apparatus 100 is a PC, the OS is, for example, Windows (registered trademark) or Unix (registered trademark) of Microsoft Corporation. In addition, the application program includes an image recognition application that performs image recognition using the machine learning model, a concept image generation application that generates a concept image of the machine learning model in multiple stages, a concept presentation application that presents a concept serving as a determination basis when the machine learning model performs image recognition in multiple stages, and a concept correction application that corrects the concept of the machine learning model.

The host bus 2004 is connected to the expansion bus 2006 via the bridge 2005. The expansion bus 2006 is, for example, a peripheral component interconnect (PCI) bus or PCI Express, and the bridge 2005 is based on the PCI standard. However, the information processing apparatus 2000 does not necessarily have a configuration in which circuit components are separated by the host bus 2004, the bridge 2005, and the expansion bus 2006, and thus may be configured in such a way that almost all circuit components are implemented by being interconnected using a single bus (not illustrated).

The interface unit 2007 connects peripheral devices such as the input unit 2008, the output unit 2009, the storage unit 2010, the drive 2011, and the communication unit 2013 according to the standard of the expansion bus 2006. However, not all the peripheral devices illustrated in FIG. 10 are essential, and the information processing apparatus 2000 may further include a peripheral device (not illustrated). Furthermore, the peripheral device may be built in the main body of the information processing apparatus 2000, or some peripheral devices may be externally connected to the main body of the information processing apparatus 2000.

The input unit 2008 includes an input control circuit that generates an input signal on the basis of an input from a user and outputs the input signal to the CPU 2001, and the like. In a case where the information processing apparatus 2000 is a PC, the input unit 2008 may include a keyboard, a mouse, and a touch panel, and may further include a camera and a microphone.

The output unit 2009 includes, for example, a display device such as a liquid crystal display (LCD) device, an organic electro-luminescence (EL) display device, and a light emitting diode (LED). As in the present embodiment, in a case where image recognition using a machine learning model and presentation of a determination basis of the machine learning model are performed on the information processing apparatus 2000, a recognition result and the determination basis are presented using a display device. Furthermore, the output unit 2009 may include an audio output device such as a speaker and a headphone, and output at least a part of a message to the user displayed on the UI screen as an audio message.

The storage unit 2010 stores files such as programs (application, OS, or the like) to be executed by the CPU 2001 and various pieces of data. The storage unit 2010 may function as, for example, the data accumulation unit 801 and accumulate a large number of data to be subjected to multivariate analysis. Although the storage unit 2010 includes, for example, a mass storage device such as a solid state drive (SSD) or a hard disk drive (HDD), the storage unit 2010 may include an external storage device.

A removable recording medium 2012 is a cartridge-type recording medium such as a microSD card, for example. The drive 2011 performs reading and writing operations on a removable storage medium 113 loaded therein. The drive 2011 outputs data read from the removable recording medium 2012 to the RAM 2003 and the storage unit 2010, and writes data on the RAM 2003 and the storage unit 2010 to the removable recording medium 2012.

The communication unit 2013 is a device that performs wireless communication such as Wi-Fi (registered trademark), Bluetooth (registered trademark), or a cellular communication network such as 4G or 5G. Furthermore, the communication unit 2013 may include a terminal such as a universal serial bus (USB) or a high-definition multimedia interface (HDMI (registered trademark)), and may further include a function of performing data communication with a USB device such as a scanner or a printer, a display, or the like.

### Industrial Applicability

The present disclosure has been described in detail with reference to the specific embodiment. However, it is obvious that those skilled in the art can make modifications and substitutions of the embodiment without departing from the gist of the present disclosure.

In the present specification, the embodiment in which the present disclosure is mainly applied to a convolutional neural network has been mainly described, but the gist of the present disclosure is not limited thereto. The present disclosure can be similarly applied to a neural network of another form and a machine learning model including various configurations other than the neural network.

Furthermore, in the present specification, the embodiment in which the present disclosure is mainly applied to a machine learning model that performs image classification has been mainly described, but the gist of the present disclosure is not limited thereto. The present disclosure can be similarly applied to machine learning models for various applications that perform inference such as recognition, identification, and prediction other than image classification.

In short, the present disclosure has been described in an illustrative manner, and the contents disclosed in the present specification should not be interpreted in a limited manner. To determine the gist of the present disclosure, the claims should be taken into consideration.

Note that the present disclosure may also have the following configurations.

(1) An information processing apparatus including: a generation unit that generates a concept image identified in each stage of a machine learning model including a plurality of stages;
an identification unit that identifies a contribution degree of a concept in each stage when the machine learning model processes an input image on a basis of activation of the concept image; and
a presentation unit that presents a concept serving as a determination basis in each stage of the machine learning model on a basis of an identification result by the identification unit.

(2) The information processing apparatus according to (1), in which
the generation unit generates a plurality of concept images for each stage of the machine learning model and groups the plurality of concept images into a concept image group on a basis of a concept, and
the identification unit calculates a contribution degree of a corresponding concept on a basis of activation of each concept image group in each stage of the machine learning model.

(3) The information processing apparatus according to (2), further including
a correction unit that corrects an identification result of the machine learning model by correcting activation of a concept image group corresponding to a concept for which a determination error has occurred.

(4) The information processing apparatus according to any one of (1) to (3), in which
the identification unit calculates a contribution degree of a concept on a basis of a result of identifying a feature map of an input image extracted at each stage of the machine learning model by a linear discriminator configured with a concept image at a corresponding stage.

(5) The information processing apparatus according to any one of (1) to (3), in which
the identification unit calculates a contribution degree of a concept on a basis of a similarity between vectors acquired by performing singular value decomposition on each of a feature map of an input image extracted at each stage of the machine learning model and a concept image at a corresponding stage.

(6) The information processing apparatus according to any one of (4) and (5), in which
the identification unit calculates a contribution degree of a concept by using a concept compressed image group obtained by compressing a concept image group grouped on a basis of a concept for each stage of the machine learning model.

(7) The information processing apparatus according to any one of (2) to (6), in which
the machine learning model is a convolutional neural network including a plurality of convolution layers, and the generation unit generates a concept image including a feature map extracted in each of the convolution layers when a random image is input to the convolutional neural network.

(8) The information processing apparatus according to (7), in which
the generation unit performs labeling representing a concept to a plurality of generated concept images in each convolution layer, and groups the plurality of generated concept images into a concept image group on a basis of the label.

(9) The information processing apparatus according to (8), in which
the generation unit performs labeling on a concept image using a CLIP model.

(10) An information processing method including:
a generation step of generating a concept image identified in each stage of a machine learning model including a plurality of stages;
an identification step of identifying a contribution degree of a concept in each stage when the machine learning model processes an input image on a basis of activation of the concept image; and
a presentation step of presenting a concept serving as a determination basis in each stage of the machine learning model on a basis of an identification result in the identification step.

(11) A computer program described in a computer readable format to cause a computer to function as:
a generation unit that generates a concept image identified in each stage of a machine learning model including a plurality of stages;
an identification unit that identifies a contribution degree of a concept in each stage when the machine learning model processes an input image on a basis of activation of the concept image; and
a presentation unit that presents a concept serving as a determination basis in each stage of the machine learning model on a basis of an identification result by the identification unit.

### REFERENCE SIGNS LIST

100 Information processing apparatus
101 Concept image generation unit
102 Concept correction unit
103 Concept identification unit
400 Convolutional neural network
401 to 404 Convolution layer
405 GAP layer
466 to 408 Fully connected layer
2000 Information processing apparatus
2001 CPU
2002 ROM
2003 RAM
2004 Host bus
2005 Bridge
2006 Expansion bus
2007 Interface unit
2008 Input unit
2009 Output unit
2010 Storage unit
2011 Drive
2012 Removable recording medium
2013 Communication unit

1. An information processing apparatus comprising:
a generation unit that generates a concept image identified in each stage of a machine learning model including a plurality of stages;
an identification unit that identifies a contribution degree of a concept in each stage when the machine learning model processes an input image on a basis of activation of the concept image; and
a presentation unit that presents a concept serving as a determination basis in each stage of the machine learning model on a basis of an identification result by the identification unit.

2. The information processing apparatus according to claim 1, wherein
the generation unit generates a plurality of concept images for each stage of the machine learning model and groups the plurality of concept images into a concept image group on a basis of a concept, and
the identification unit calculates a contribution degree of a corresponding concept on a basis of activation of each concept image group in each stage of the machine learning model.

3. The information processing apparatus according to claim 2, further comprising
a correction unit that corrects an identification result of the machine learning model by correcting activation of a concept image group corresponding to a concept for which a determination error has occurred.

4. The information processing apparatus according to claim 1, wherein
the identification unit calculates a contribution degree of a concept on a basis of a result of identifying a feature map of an input image extracted at each stage of the machine learning model by a linear discriminator configured with a concept image at a corresponding stage.

5. The information processing apparatus according to claim 1, wherein
the identification unit calculates a contribution degree of a concept on a basis of a similarity between vectors acquired by performing singular value decomposition on each of a feature map of an input image extracted at each stage of the machine learning model and a concept image at a corresponding stage.

6. The information processing apparatus according to claim 4, wherein
the identification unit calculates a contribution degree of a concept by using a concept compressed image group obtained by compressing a concept image group grouped on a basis of a concept for each stage of the machine learning model.

7. The information processing apparatus according to claim 2, wherein
the machine learning model is a convolutional neural network including a plurality of convolution layers, and
the generation unit generates a concept image including a feature map extracted in each of the convolution layers when a random image is input to the convolutional neural network.

8. The information processing apparatus according to claim 7, wherein
the generation unit performs labeling representing a concept to a plurality of generated concept images in each convolution layer, and groups the plurality of generated concept images into a concept image group on a basis of the label.

9. The information processing apparatus according to claim 8, wherein
the generation unit performs labeling on a concept image using a CLIP model.

10. An information processing method comprising:
a generation step of generating a concept image identified in each stage of a machine learning model including a plurality of stages;
an identification step of identifying a contribution degree of a concept in each stage when the machine learning model processes an input image on a basis of activation of the concept image; and
a presentation step of presenting a concept serving as a determination basis in each stage of the machine learning model on a basis of an identification result in the identification step.

11. A computer program described in a computer readable format to cause a computer to function as:
a generation unit that generates a concept image identified in each stage of a machine learning model including a plurality of stages;
an identification unit that identifies a contribution degree of a concept in each stage when the machine learning model processes an input image on a basis of activation of the concept image; and
a presentation unit that presents a concept serving as a determination basis in each stage of the machine learning model on a basis of an identification result by the identification unit.
